(19) United States
(12) Patent Application Publication
(10) Pub. No.: US 2006/0202172 A1
(43) Pub. Date: Sep. 14, 2006

(54) Electrically conductive coating lacquer paints

(76) Inventors: Karl Herrmann, Schambach (DE); Wolf-Rudiger Karl, Duisburg (DE); Klaus Pipplies, Moers (DE); Klaus Schulte, Alpen (DE)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/435,882

(22) Filed: May 18, 2006

Related U.S. Application Data
(63) Continuation of application No. 09/530,415, filed on Sep. 20, 2001, now abandoned.

(30) Foreign Application Priority Data
Oct. 31, 1997 (DE) 197 48 226.0
Jul. 30, 1998 (DE) 198 34 284.5

(51) Int. Cl. H01B 1/12

(52) U.S. Cl. 252/500

(57) ABSTRACT

The present invention relates to a polymer-lacquer based paint, characterized in that in addition to the lacquer paint constituents are usual per se, it contains suitable conductive additives, by which the paint lacquer is provided with antistatic properties.

The present invention also relates to a method for lacquering plastic surfaces comprising lacquering plastic surfaces with a lacquer paint, wherein the lacquer paint comprises a polymer-based lacquer and conductive additives, by which the lacquer paint is provided with anti-static properties, and the conductive additives are chosen from semiconductor-doped BaSO₄.

### CROSS REFERENCE TO RELATED APPLICATIONS

This application is a continuation of U.S. application Ser. No. 09/530,415, filed May 1, 2000, which is the National Stage of International Application No. PCT/EP98/06724, filed Oct. 22, 1998, and the entire disclosures of which are incorporated herein by reference.

Polymer-based lacquer paints, which are used in particular for coating plastics surfaces, are the subject of the present invention.

When electrically uncharged substances having different dielectric constants touch, electrons migrate out of the one substance into the other. If the two substances are separated quickly, the charge displacement obtained in this way is retained and can lead to the development of high electrostatic potentials. This phenomenon is often to be observed in plastics, which, because of their insulating properties, can be relatively easily electrostatically charged. The sudden discharge of such electrostatically charged plastics can become a source of danger in certain cases. It is therefore generally customary in those cases in which electrostatically charged plastics can represent a source of danger to provide a so-called anti-static provision for the plastics surfaces in order to allow electrostatic charges to flow off in a controlled manner and thus to be able to prevent effectively the danger of sudden discharges.

In use, other disadvantage are also not infrequently caused by the insulating properties of plastics. Because of their insulating properties, for example, it is not possible simply to lacquer paint them by means of the so-called electrostatic coating. This has a disadvantageous effect particularly if insulating plastics are to be combined together with electrically conductive materials and electrostatically lacquer painted together in one working step, a process which is entirely usual in the automobile industry and its suppliers and in which, for example, plastics bumpers are connected to metal body portions. However, in order to be able to use the technique of electrostatic lacquer painting, the treatment of plastics surfaces with a black or dark grey electrically conductive undercoat has therefore been hitherto a prerequisite. Plastics surfaces equipped in this way were then able to be electrostatically over-lacquer painted with the actual coating lacquer paint.

The object of the present invention has therefore been to make available lacquer paints which eliminate the disadvantages which occur in the case of the lacquer painting of plastics surfaces. A further object of the present invention has consisted in providing coating lacquer paints with anti-static properties in order to be able to dispense with the electrically conductive undercoat.

Apart from this, the lacquer paints in accordance with the invention are to satisfy demands with respect to mechanical and optical properties, corrosion protection and weather resistance.

The object has been achieved in accordance with the invention by the features of the main claim. Preferred developments are characterised in the sub-claims.

The invention proposes providing lacquer paints which are known per se with anti-static properties by means of the addition of suitable additives. Soots with conductivity, metal powders, mica flakes with a conductive coating, fine-particle SnO₂ whether surface-treated or non-surface-treated, semiconductor-doped TiO₂, semiconductor-doped BaSO₄ and a series of organic additives are counted among the additives to be used in accordance with the invention.

As a result of the solution in accordance with the invention, there are placed in the lacquer paint sufficiently conductive particles which form in the lacquer paint matrix a network of electrically conductive paths, by way of which electric charges can flow away in a targeted manner (percolation theory). The amount of conductive particles in the polymer matrix of the lacquer paint that is required for the anti-static equipping and the resulting conductivity of the compound system are determined by the percolation theory.

In a preferred embodiment, the combination with suitable other fillers/pigments which are non-conductive is provided. As a result of this measure, the so-called extender effect is exploited, without losses resulting in the conductivity of the compound system. This extender effect makes it possible to reduce the amount of conductive additives that is necessary per se. A surface resistance of 10² to 10⁹ Ohm that fulfils the criterion for anti-static coatings usually develops in the case of a pigmentation with the conductive additives and/or the non-conductive fillers/pigments of 5-35% ‘PVC’ (pigment volume concentration).

As a result of the suitable choice and combination of the individual non-conductive fillers/pigments and the electrically conductive additives, practically any polymer-based lacquer paint can be provided with anti-static properties. In this way, a suitable lacquer paint can be formulated in accordance with the invention for any decorative design.

In order to optimise the lacquer paints in accordance with the invention, in certain cases provision can be made for controlled flocculation with comparatively less thermodynamically favourable solvents or with suitable additives which are known per se to the skilled person. In most cases, a comparatively small degree of filling, leads to improvements in all of the above-mentioned criteria, while the desired anti-static property is retained.

In order to ensure the efficiency of the electrically conductive additives, a sufficient dispersal of both the electrically conductive additives and of the non-conductive fillers/pigments is necessary; the manner in which this is to be achieved is known per se to the skilled person.

The addition of 0.05-20.0% ‘PVC’ rutile-based transparent TiO₂ having a crystallite size of 5-50 nm effects non-angle-dependent (colour-tone effects) and angle-dependent (frost effect) changes. At the same time, it was possible to achieve a certain stability against UV-A and UV-B radiation by means of this addition of transparent TiO₂.

The TiO₂ particles to be used can additionally also have an inorganic doping. In this connection, the doping of the TiO₂ particles with aluminium oxide or zirconium oxide changes the weathering resistance of the lacquer paint in accordance with the invention in an advantageous way. In order to improve further the wettability of the TiO₂ particles and the dispersibility that is linked therewith, an organic after treatment can be provided in accordance with the invention.

Furthermore, the lacquer paintes in accordance with the invention, which are based on water-dilutable or solvent-containing binding agents, such as polyester resins, alkyd resins, acrylic resins, epoxy resins, for example, can preferentially be provided with chromophore pigments (for example TiO₂, organic and inorganic coloured pigments), with effect pigments (for example pearl-lustre pigments) or further fillers, such as BaSO₄, for example. The selection criteria are directed towards the properties required in later use. The hardening of the lacquer paint systems is predetermined by the choice of resin and of the additives which are used. A-hardening by UV or EB radiation can likewise be carried out successfully in the case of a suitable choice of the additives. In order to optimise the lacquer paint compositions with respect to mechanical or optical properties, in order to improve the rheology, etc, commonly employed additives can also be used in the formulations which form the basis of the invention. When choosing the additives, it is only necessary to take care that the network of electrically conductive paths is not interrupted, because the surface resistance of the lacquer paint would be increased drastically again as a result of this (percolation theory).

The lacquer paintes in accordance with the invention can be prepared according to methods which are known per se.

It is particularly advantageous that, as a result of the solution in accordance with the invention, a working step can be omitted when treating plastics surfaces, as a result of which, on the one hand, considerable costs are saved, and also, on the other hand, sources of error in the process are ruled out. Furthermore, the solution in accordance with the invention also relieves the strain on the environment, because, by dispensing with the conductive primer (electrostatic undercoat), one no longer wastes the solvents which are generally used.

In order to demonstrate the suitability of the lacquer paints formulated in accordance with the invention, silver, green and red metallic lacquer paints based on cellulose acetate butyrate/polyester/melamine resin were each provided with anti-static properties by means of a transparent, electrically conductive BaSO₄. The composition for the silver metallic lacquer paint formulated in accordance with the invention is given by way of example:

| | |
|---|---|
| cellulose acetatobutyrate (15%) | 32.0% by weight |
| polyester (65%) | 16.0% by weight |
| melamine resin | 5.5% by weight |
| aluminium pigment | 2.4% by weight |
| conductive BaSO₄ | 16.1% by weight |
| solvents and lacquer paint | 28.0% by weight |
| auxiliaries | |

Electrically conductive BaSO₄ is known per se from EP-A-0 459 552. It consists in principle of BaSO₄ particles which are sheathed with a layer of Sb₂O₃-doped SnO₂. Sacon P 401 can be used, for example. The plastics surfaces treated with these metallic lacquer paints in accordance with the invention were first of all examined purely visually. No significant differences from plastic surfaces treated with known metallic lacquer paints could be established. The lacquer paints were then measured with a spectrophotometer at D65/10°. Here as well, only small differences in the colorimetric data emerged. The maximum Delt E-values were 1.30.

A further example of a lacquer paint in accordance with the invention is the following formulation of a light grey electrically conductive base coat based on polyester/melamine resin.

| | | |
|---|---|---|
| Dynapol H 703 | 26.7% | by weight |
| Maprenal MF 650 | 7.9% | by weight |
| conductive BaSO₄ | 29.4% | by weight |
| Hombitan R 522 | 11.0% | by weight |
| xylene/MPA 2/1 | 21.0% | by weight |
| Modaflow (5% in Solvesso 100) | 4.0% | by weight |
| Surface resistance | 10⁴ | Ohm |

A further advantageous embodiment of the invention provides for the so-called controlled flocculation. This controlled flocculation can be generated by a suitable choice of special additives and solvents which are thermodynamically unfavourable for the system. Even with this, the anti-static property of the lacquer paint in accordance with the invention is not lost. By way of example, tests were carried out in polyester-resin systems, acrylate-resin systems and epoxy-resin systems.

| | |
|---|---|
| base | mod. |
| [% by weight] | [% by weight] |

a) Acrylate system

| | | |
|---|---|---|
| Macrynal SM 540 | 19.2 | 24.6 |
| IPDI-B-1370 | 14.8 | 19.0 |
| Irgastab DBTL | 0.02 | 0.01 |
| diethylamine | 0.13 | 0.11 |
| silicone oil L 050 | 0.33 | 0.01 |
| Solvesso 100 | 1.85 | — |
| xylene | 16.3 | — |
| MPA | 17.1 | 1.55 |
| Nbutanol | — | 21.0 |
| i-propanol | — | 7.1 |
| conductive BaSO₄ | 30.2 | 24.7 |
| Anti Terra 204 | — | 1.9 |
| surface resistance | 10⁶ | 10⁶ Ohm |

b) polyester-resin system

| | | |
|---|---|---|
| Dynapol LH 812 | 34.0 | 40.2 |
| Cymel 303 | 5.11 | 6.03 |
| Vestorit Catalyst 1203 | 1.39 | 1.64 |
| Solvesso 200 | 4.6 | — |
| xylene | 8.5 | 6.3 |
| MPA | 7.8 | — |
| butanol | — | 10.0 |
| i-propanol | — | 5.5 |
| conductive BaSO₄ | 38.5 | 28.8 |
| Anti Terra 204 | — | 1.61 |
| surface resistance | 10⁵ Ohm | 10⁵ Ohm |

c) epoxy-resin system

| | | |
|---|---|---|
| Epikote 1007 | 19.5 | 23.4 |
| butanol | 17.1 | 21.4 |
| xylene | 17.1 | 16.8 |
| MIBK | 2.8 | 3.4 |
| Beetle BE 681 | 7.8 | 9.5 |
| conductive BaSO₄ | 35.7 | 22.8 |
| Anti Terra 204 | — | 1.9 |
| Byk ES 80 | — | 0.9 |
| surface resistance | 10⁴ Ohm | 10⁴ Ohm |

1-15. (canceled)

16. A method for lacquering plastic surfaces comprising lacquering plastic surfaces with a lacquer paint, wherein the lacquer paint comprises a polymer-based lacquer and conductive additives, by which the lacquer paint is provided with anti-static properties, and the conductive additives are chosen from semiconductor-doped BaSO₄.

17. The method according to claim 16, characterized in that the lacquer paint contains up to 35% PVC of the semiconductor-doped BaSO₄.

18. The method according to claim 16, characterized in that BaSO₄ particles coated with a layer of Sb₂O₃-doped SnO₂ are used as the electrically conductive BaSO₄.

19. The method according to claim 16, characterized in that cellulose acetate butyrate/polyester/melamine resin is used as a polymer base of the polymer-based lacquer.

20. The combination of a plastic surface and a lacquer paint applied to the plastic surface for providing the plastic surface with anti-static properties, wherein the lacquer paint comprises a polymer-based lacquer and conductive additives, by which the lacquer paint is provided with anti-static properties, and the conductive additives are chosen from semiconductor-doped BaSO₄.

21. The combination according to claim 20, characterized in that the lacquer paint contains up to 35% PVC of the semiconductor-doped BaSO₄.

22. The combination according to claim 20, characterized in that BaSO₄ particles coated with a layer of Sb₂O₃-doped SnO₂ are used as the electrically conductive BaSO₄.

23. The combination according to claim 20, characterized in that cellulose acetate butyrate/polyester/melamine resin is used as a polymer base of the polymer-based lacquer.

24. The method according to claim 17, characterized in that BaSO₄ particles coated with a layer of Sb₂O₃-doped SnO₂ are used as the electrically conductive BaSO₄.

25. The method according to claim 17, characterized in that cellulose acetate butyrate/polyester/melamine resin is used as a polymer base of the polymer-based lacquer.

26. The method according to claim 18, characterized in that cellulose acetate butyrate/polyester/melamine resin is used as a polymer base of the polymer-based lacquer.

27. The combination according to claim 21, characterized in that BaSO₄ particles coated with a layer of Sb₂O₃-doped SnO₂ are used as the electrically conductive BaSO₄.

28. The combination according to claim 21, characterized in that cellulose acetate butyrate/polyester/melamine resin is used as a polymer base of the polymer-based lacquer.

29. The combination according to claim 22, characterized in that cellulose acetate butyrate/polyester/melamine resin is used as a polymer base of the polymer-based lacquer.
